(19) United States
(12) Patent Application Publication
(10) Pub. No.: US 2023/0158516 A1
(43) Pub. Date: May 25, 2023

(54) EASY-TO-SWITCH WATER OUTFLOW DEVICE

(71) Applicant: Fujian Onlytop Sanitaryware Co.,Ltd., Zhangzhou (CN)

(72) Inventors: Jiaping Xu, Zhangzhou (CN); Kunjing Fan, Zhangzhou (CN); Yifan Chen, Zhangzhou (CN)

(21) Appl. No.: 17/662,223

(22) Filed: May 5, 2022

(30) Foreign Application Priority Data
Nov. 19, 2021 (CN) 202111397988.6

(51) Int. Cl. B05B 1/16

(52) U.S. Cl. CPC B05B 1/1636

(57) ABSTRACT

An easy-to-switch water outflow device includes a body, a water outflow assembly and a water channel switching device. The water outflow assembly is at least capable of spraying out two different functional water sprays; for each of the functional water sprays, the water outflow assembly is provided with at least one water inlet communicating with a water channel of the functional water spray, and the water outflow assembly is provided with a pivoting passage at a position corresponding to the water inflow terminal. The water channel switching device includes a water distribution valve spool, a connecting rod and a switching handle. By rotating the switching handle, the water outlet of the water distribution valve spool can be selectively docked and communicated with the water inlet, thereby realizing the switching of water channels of different functional water sprays of the water outflow device.

### CROSS REFERENCE TO RELATED APPLICATIONS

This application claims priority to Chinese Patent Application No. 202111397988.6, filed on Nov. 19, 2021, the entire contents of which are incorporated herein by reference.

### FIELD OF THE INVENTION

The present disclosure relates to a shower device, and in particular to an easy-to-switch water outflow device.

### BACKGROUND OF THE INVENTION

With the continuous improvement of people's quality of life, the requirements on showering are also continuously increasing. The traditional water outflow device with only a single functional water spray has gradually evolved into a water outflow with different functional water sprays (such as shower water, bubble water, massage water and mist water, etc.). For the water outflow device with multiple functional water sprays, a water channel switching device is required to realize the switching of different functional water sprays. The most common practice on the market is to provide at least one water outlet on a body of the water outflow device that communicates with an external water channel, and to provide several water collecting chambers whose water channels are isolated from each other in a water outflow assembly. Each of the water collecting chambers corresponds to a water outflow terminal pre-arranged on a water outflow end face of the water outflow assembly to realize a specific functional water spray; at the same time, at least one water inlet communicating with the corresponding water collecting chamber is provided on an end face of the water outflow assembly on a side facing the water outlet; by rotationally adjusting the relative positional relationship between the water outflow assembly and the body in a circumferential direction, the water outlet on the body can be selectively docked with the water inlet on the water outflow assembly, so as to conduct the water channels of the multiple functional water sprays.

### SUMMARY OF THE INVENTION

An object of the present disclosure is to provide a water outflow device for a multi-functional water spray. By changing the structure of a water channel switching device of the water outflow device, it is easier for the water outflow device to perform water channel switching, and the water outflow device can have a long service life.

In order to achieve the above object, the present disclosure provides a water outflow device, which includes:

a body, on which an accommodating chamber is formed, a water inflow terminal communicating with an external water source being formed in the accommodating chamber;

a water outflow assembly, which is fixedly installed on the accommodating chamber of the body, and which is at least capable of spraying out two different functional water sprays, in which for each of the functional water sprays, the water outflow assembly is provided with at least one water inlet communicating with a water channel of the functional water spray on an end face of the water outflow assembly on a side facing the body; the water outflow assembly is provided with a through pivoting passage at a position corresponding to the water inflow terminal, and the pivoting passage is isolated from water channels in the water outflow assembly; and

a water channel switching device, which includes a water distribution valve spool, a connecting rod and a switching handle; in which the water distribution valve spool is a cylindrical member; the water distribution valve spool is located between the accommodating chamber of the body and the water outflow assembly, and the water distribution valve spool is formed with a water inflow passage that can be rotationally docked with the water inflow terminal on an end face on a side facing the accommodating chamber, and is formed with at least one water outlet on the other end face; water from the external water source flows into the water distribution valve spool through the water inflow terminal and the water inflow passage in sequence, and flows out through the water outlet; the switching handle is arranged on an outer end face of the water outflow assembly; the connecting rod is built in the pivoting passage, with one end of the connecting rod being fixedly connected to the water distribution valve spool, and the other end of the connecting rod being fixedly connected to the switching handle; by driving the switching handle to swing circumferentially around a central axis X of the pivoting passage, the water outlet of the water distribution valve spool can be selectively docked with the water inlet of the water outflow assembly so that the water channel is conducted, thereby realizing the switching of water channels of different functional water sprays of the water outflow device.

By adopting the above design, in the water outflow device of the present disclosure, the water outflow assembly is fixedly installed on the accommodating chamber of the body, and by adding a water distribution valve spool between the body and the water outflow assembly, the water selectively flows to the water inlet of the water outflow assembly through the water outlet of the water distribution valve spool, and is sprayed outward after passing through the water accommodating chamber of the water outflow assembly. Since the amount of water that can be accumulated in the water distribution valve spool is much lower than the amount of water accumulated in the water outflow assembly, which makes the water pressure inside the water distribution valve spool lower than the water pressure in the water outflow assembly, a smaller pushing force can be used to drive the water distribution valve spool to rotate in the circumferential direction through the switching handle so as to realize the switching of the water channel. In addition, the water outflow assembly of the present disclosure is fixedly arranged on the body and does not rotate relative to the body. It is always in a relatively stable state, thus avoiding the previous situation of wear of internal fasteners or connectors caused by rotating the water outflow assembly, which would otherwise shorten the service life; whereas the water channel switching method of the common water outflow devices needs to rotate the entire water outflow assembly, so that the different water inlets on the water outflow assembly are docked with the water outlet of the body respectively to realize the water channel switching. However, when using this method to switch water channels, the water collecting chamber inside the water outflow assembly bears a certain water pressure, especially when the size of the water outflow device is relatively large, such as having a diameter of more than 6 inches, in which case the water pressure is relatively large, thus causing the water outflow assembly to be labor-consuming when rotating for switching; at the same time, since the water outflow assembly is often rotated, and the overall area and weight of the water outflow assembly are both relatively large, it is easy to cause mutual wear between the water outflow assembly and the body, so that there is a gap when docking the water outlet of the body with the water inlet of the water outflow assembly, which leads to water leakage and shortens the overall service life of the product; however, the water channel switching device of the water outflow device provided in the present disclosure well solves these technical problems.

### BRIEF DESCRIPTION OF THE DRAWINGS

The specific description given as a non-limiting example better explains what the present disclosure includes and how it can be carried out; moreover, the description is set forth with reference to the accompanying drawings, in which:

FIG. 1 is a first schematic partial exploded view of a water outflow device of the present disclosure;

FIG. 2 is a second schematic partial exploded view of the water outflow device of the present disclosure;

FIG. 3 is a cross sectional view of the water outflow device of the present disclosure;

FIG. 4 is a schematic exploded view of a water distribution valve spool of the present disclosure;

FIG. 5 is a schematic exploded view of the water outflow device of the present disclosure; and

FIG. 6 is a schematic assembly view of the water outflow device of the present disclosure.

### DETAILED DESCRIPTION OF THE EMBODIMENT(S) OF THE INVENTION

The present disclosure will be described in detail below with reference to the accompanying drawings and specific embodiments.

Throughout the claims and the description, unless otherwise defined, terms “first”, “second” and the like are used to distinguish different objects, rather than describing a specific order.

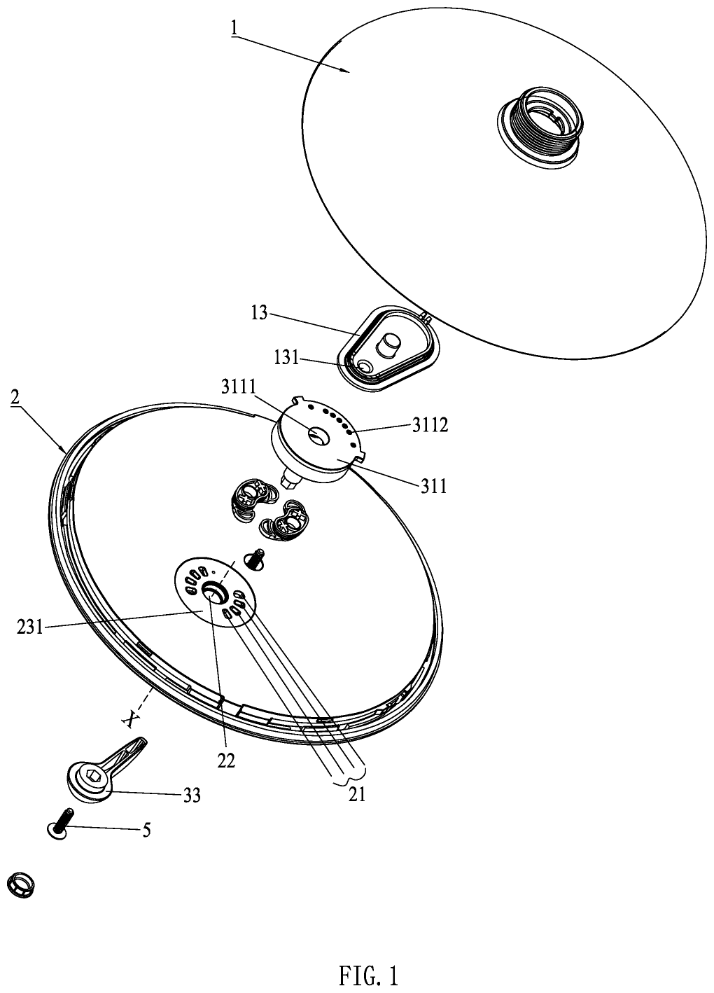

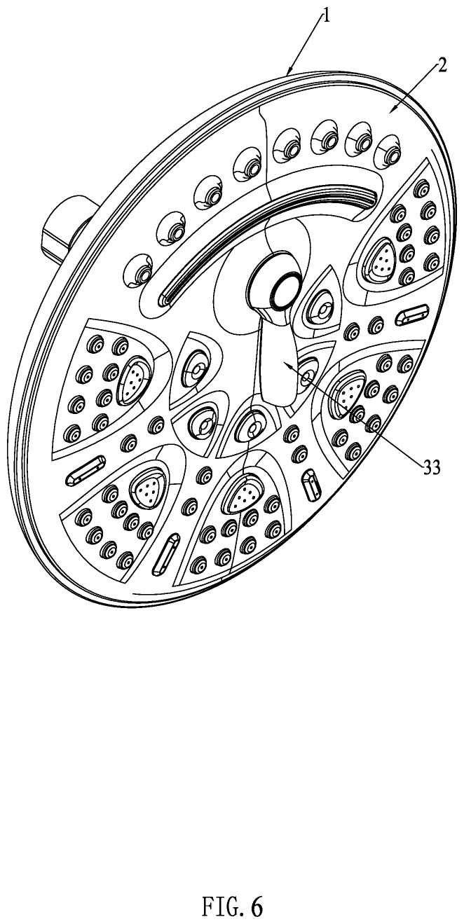

As shown in FIGS. 1 to 6, a water outflow device includes a body 1, a water outflow assembly 2 and a water channel switching device 3.

The body 1 may be the body of a hand-held shower head or the body of a top-spout shower head, an accommodating chamber 11 is formed on the body 1, and an inner wall of the accommodating chamber 11 forms a water collecting trough 12 that communicates with an external water source. An outer end of the water collecting trough 12 is fixedly connected with a water blocking cover plate 13. In this embodiment, the water blocking cover plate 13 and the body 1 are of a split design. Of course, it cannot be excluded that with the improvement of the production process in the future, such as the popularization of 3D printing technology, the water blocking cover plate 13 and the body 1 can be integrally formed. On the water blocking cover plate 13, a water-passing protrusion extends outward and communicates with the water channel in the water collecting trough 12, and the water-passing protrusion is a water inflow terminal 131.

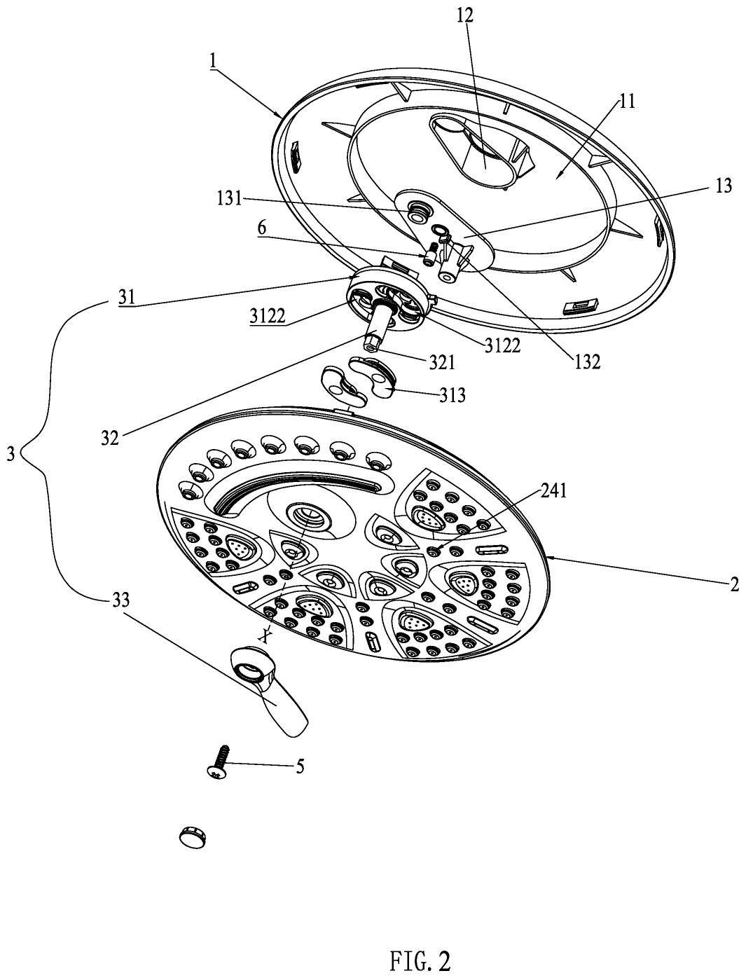

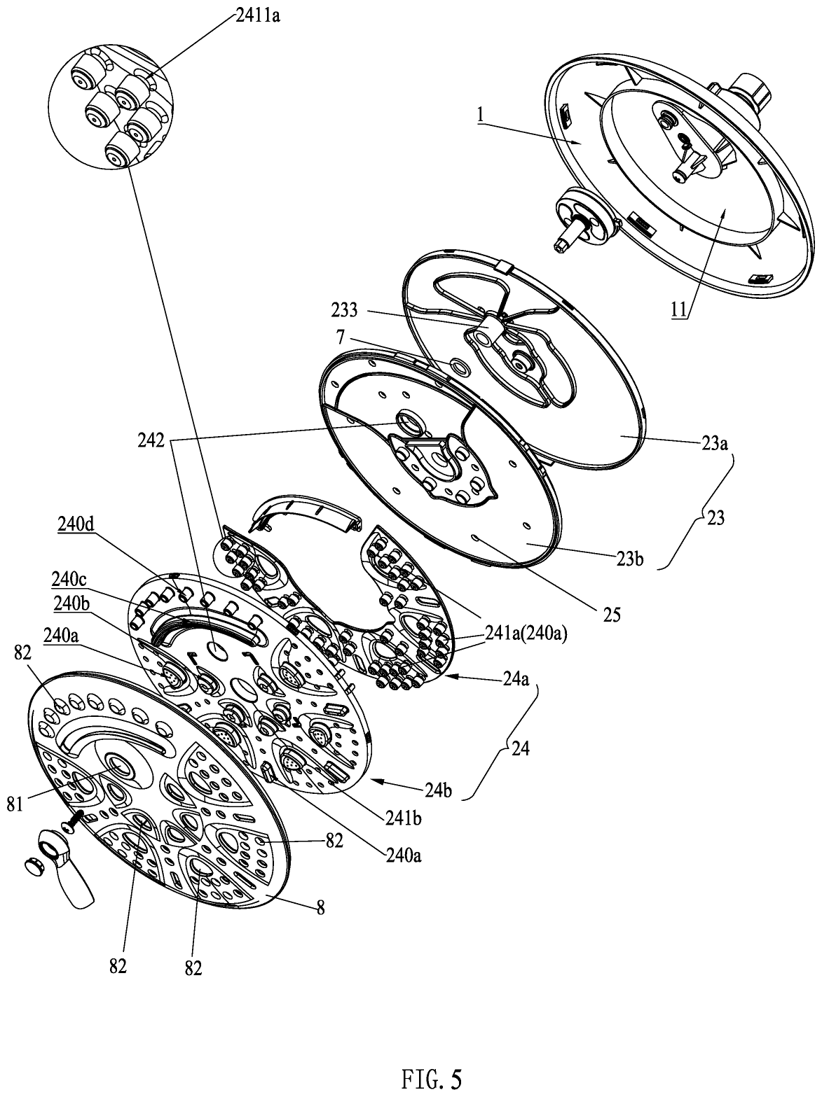

As shown in FIG. 2, the water outflow assembly 2 is fixedly installed on the accommodating chamber 11 of the body 1. As shown in FIG. 5, the water outflow assembly 2 includes a water distribution assembly 23 and a water outflow panel assembly 24 that are fixedly connected to each other. The water distribution assembly 23 and the water outflow panel assembly 24 are formed with pivoting passages 22 communicating with each other at a position corresponding to the water inflow terminal 131. More specifically, the water distribution assembly 23 includes a water distribution disc 23a and a water blocking sheet 23b in sequence from the inside to the outside in an axial direction. The water distribution disc 23a and the water blocking sheet 23b are snap-fitted and fixedly connected to each other, so that an inner chamber thereof forms at least two second water accommodating chambers 232 whose water channels are isolated from each other. In this embodiment, there are formed four second water accommodating chambers 232 whose water channels are isolated from each other. A side of the water distribution disc 23 that faces the accommodating chamber 11 is a water inflow end face, and an end face of the water blocking sheet 23b on a side away from the water distribution disc 23a is a water outflow end face. Each of the second water accommodating chambers 232 is provided with at least one water inlet 21 on the water inflow end face at the corresponding position, which communicates with the water channel thereof; at the same time, each of the second water accommodating chambers 232 is provided with at least one water-passing hole 25 on the water outflow end face at the corresponding position, which communicates with the water channel thereof. In this embodiment, two water inlets 21 are preferably arranged symmetrically on each of the second water accommodating chambers 232 (as shown in FIG. 1). By increasing a through-flow area of the water inlet 21 of each second water accommodating chamber 232, a flow rate flowing into each second water accommodating chamber 232 is increased. The water outflow panel assembly 24 includes a water outflow rubber pad 24a and a water outflow surface cover 24b in sequence from the inside to the outside in the axial direction. The water outflow rubber pad 24a is provided with a plurality of first water outflow protrusions 241a, and each of the first water outflow protrusions 241a has a water-passing hole formed thereon. The water outflow surface cover 24b is formed with a plurality of fifth through-holes 241b at positions corresponding to the first water outflow protrusions 241a. In this embodiment, the water outflow rubber pad 24a is embedded in an inner end face of the water outflow surface cover 24b through the injection molding process; at the same time, the first water outflow protrusions 241a of the water outflow rubber pad 24a protrude from the corresponding fifth through-holes 241b of the water outflow surface cover 24b (the diameter of the fifth through-holes 241b is smaller than an outer diameter of the first water outflow protrusions 241a at this time; but an indented annular groove 2411a is formed at the bottom of the first water outflow protrusion 241a, and the annular groove 2411a is used to be fitted to the fifth through-hole 241b). Of course, the injection molding process is not the only way to join the water outflow rubber pad with the water outflow surface cover. Conventionally, through-holes may also be reserved on the water outflow surface cover, which match with the first water outflow protrusions on the water outflow rubber pad, so that the first water outflow protrusions can directly protrude out of the through-holes. The first water outflow protrusions 241a form a part of a first water outflow terminal group 240a. In this embodiment, the first water outflow terminal group 240a also includes two kinds of water outflow holes with different shapes, such as a racetrack-shaped design and a triangular prism-shaped design; at the same time, the water outflow surface cover 24b is further additionally provided with a number of second water outflow terminal group 240b, third water outflow terminal group 240c and fourth water outflow terminal group 240d capable of producing different functional water sprays. The above water outflow terminal groups 240a, 240b, 240c and 240d can only communicate with the correspondingly arranged water-passing holes 25 of the second water accommodating chamber 232, so as to generate specific functional water sprays, so that the water outflow surface cover 24b can spray out four different functional water sprays, such as shower water sprays, bubble water sprays, waterfall sprays and columnar water sprays; however, the specific water sprays formed by different water outflow terminal groups are not the focus of protection of the present disclosure, and the generation mechanism of the above-mentioned different functional water sprays is a conventional technical means, which will not be described in detail here. In short, through the different water outflow terminal groups 240a, 240b, 240c and 240d on the water outflow panel assembly 24, different functional water sprays can be generated. More preferably, in general, in order to make the entire water outflow device have a better industrial design aesthetic, a decorative surface cover 8 is further fixed on an outer end face of the water outflow surface cover 24b. As shown in FIG. 5, the decorative surface cover 8 is provided with a third through-hole 81 at a position corresponding to a second through-hole 242, and is provided with a plurality of matching fourth through-holes 82 at positions corresponding to the water outflow terminal groups 240a, 240b, 240c, and 240d.

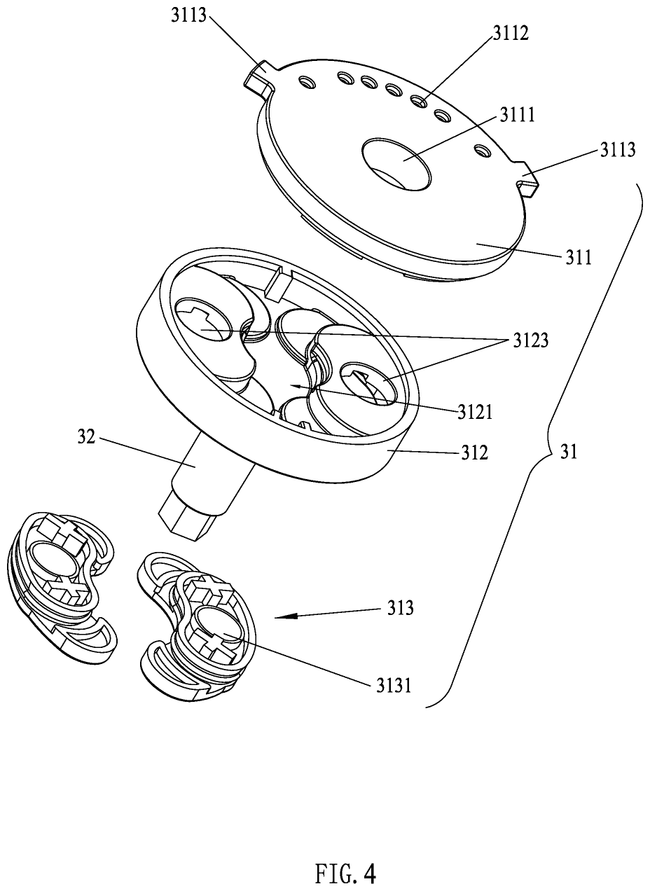

As shown in FIG. 4, the water channel switching device 3 includes a water distribution valve spool 31, a connecting rod 32 and a switching handle 33; the water distribution valve spool 31 is a cylindrical member, which is located between the accommodating chamber 11 of the body 1 and the water distribution disc 23; the water distribution valve spool 31 includes an upper cover 311, a valve spool body 312 and two water-passing rubber pads 313. The upper cover 311 is fixedly arranged on an upper end of the valve spool body 312, and the upper cover 311 is provided with a first through-hole 3111. The first through-hole is a water inflow passage 3111, into which the water inflow terminal 131 can be inserted. A sealing ring 4 is arranged between the water inflow terminal 131 and an abutting inner wall of the first through-hole 3111, and the water distribution valve spool 31 can rotate in the circumferential direction relative to the water-passing protrusion 131. It should be noted that, it is not necessary that the water inflow terminal 131 (i.e., the water-passing protrusion) is formed on the water blocking cover plate 13 and the first through-hole is formed on the upper cover 311. As long as the two form a pivotal connection, so that the water distribution valve spool 31 can rotate in the circumferential direction relative to the water-passing protrusion, any arrangement will fall within the scope of protection of the present disclosure. For example, the first through-hole is arranged on the water blocking cover plate 13, and the first through-hole communicates with the water collecting trough 12 of the body 1; the water inflow terminal 131 (i.e., the water-passing protrusion) is arranged on the upper cover 311 at a position corresponding to the first through-hole; the water-passing protrusion and the through-hole cooperate so that the water distribution valve spool 31 can rotate relative to the first through-hole of the water blocking cover plate 13.

Preferably, as shown in FIG. 2 and FIG. 4, two stoppers 3113 extend outward on diametrical ends of the upper cover 311, and the water blocking cover plate 13 is provided with a limiting block 132 on an outer side relative to the diametrical ends of the upper cover 311. When the water distribution valve spool 31 rotates, the limiting block 132 can abut against the two stoppers 3113 of the upper cover 311 respectively for limiting. Through such a structural arrangement, a rotation between the water distribution valve spool 31 and the water blocking cover plate 13 is limited within a reasonable range.

As shown in FIG. 2 and FIG. 4, a positioning elastic post 6 is additionally provided between the upper cover 311 and the water blocking cover plate 13. A plurality of positioning countersunk holes 3112 are circumferentially distributed on the upper cover 311 with the first through-hole 3111 as the center. The positioning elastic post 6 can switch between the positioning countersunk holes 3112 and a positioning sound can be generated, prompting the user to adjust the different water outflow states of the water outflow device.

An inner chamber of the valve spool body 312 forms a first water accommodating chamber 3121, and the valve spool body 312 is symmetrically provided with two water outlets 3131 with the pivoting passage 22 as a central axis X. The two water outlets 3131 communicate with the first water accommodating chamber 3121. Correspondingly, for each functional water spray, two water inlets 21 are provided on the water inflow end face of the water distribution disc 23. The two water inlets 21 can be docked and communicated with the two water outlets 3131 of the valve spool body 312. The specific implementation is shown in FIG. 4. An end face of the valve spool body 312 on a side away from the upper cover 311 is formed with two accommodating grooves 3122, and each accommodating groove 3122 is provided therein with a water-passing through-hole 3123 communicating with the first water accommodating chamber 3121 of the valve spool body 312. The water-passing rubber pads 313 are placed in the accommodating grooves 3122, and a water outlet 3131 is provided on each water-passing rubber pad 313. Water from the external water source flows into the first water accommodating chamber 3121 of the valve spool body 312 through the water inflow terminal 131 and the first through-hole (the water inflow passage 3111) in sequence, and flows out through the water outlets 3131 of the two water-passing rubber pads 313. The water outlets 3131 are selectively docked and communicated with the water inlets 21 of the water distribution disc 23, thereby realizing the water channel switching of different functional water sprays of the water outflow device. In addition, the water-passing rubber pads 313 ensure the water outlets 3131 of the water-passing rubber pads 313 and the water inlets 21 of the water distribution disc 23 are seamlessly connected, that is, to prevent water from flowing out from gaps between the water outlets 3131 and the water inlets 21 docked with them. Preferably, an inwardly-facing end face of the water distribution disc 23 is formed with a concave abutting plane 231 in the area of the water inlets 21, and the abutting plane 231 is adapted to an outer diameter of the valve spool body 312. The valve spool body 312 rotates circumferentially relative to the abutting plane 231, and such a structural arrangement ensures a better tightness of the connection between the water outlets 3131 of the water-passing rubber pads 313 and the water inlets 21 of the water distribution disc 23.

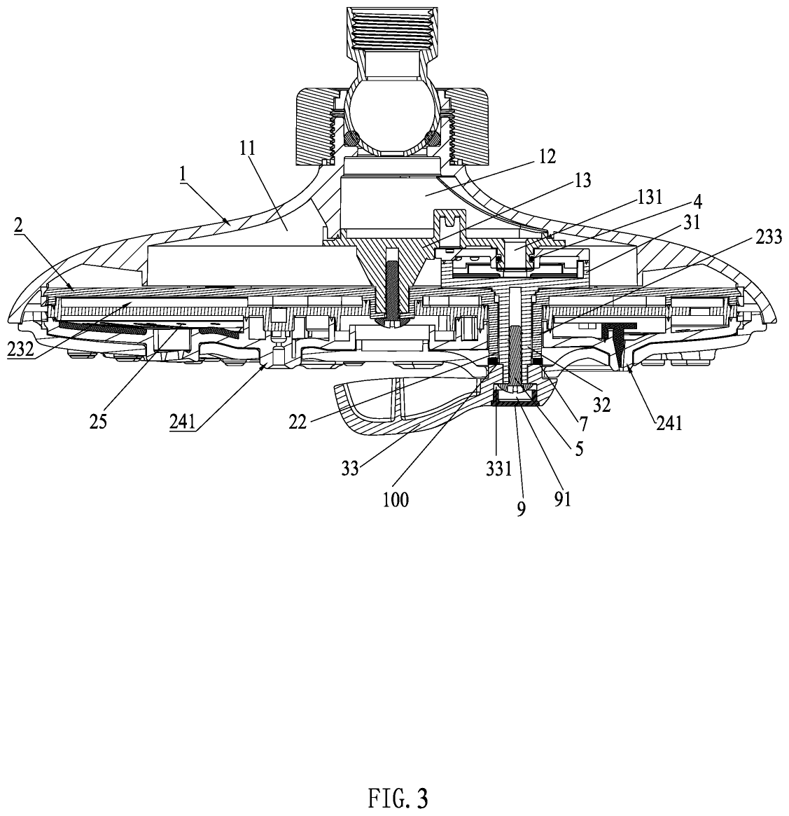

As shown in FIG. 3, the connecting rod 32 is built into the pivoting passage 22, and the connecting rod 32 is integrally formed and fixedly provided on a bottom end face of the valve spool body 312. A free end of the connecting rod 32 is a non-circular member, and a middle part of the connecting rod 32 is formed with a threaded hole 321. The switching handle 33 is arranged on an outer end face of the water outflow panel 24 to facilitate the user to operate and drive the switching handle 33. The switching handle 33 is provided with a sixth through-hole 331 with a blocking edge, and a bolt 5 passes through the sixth through-hole 331 and the threaded hole 321 in sequence from the outside to the inside. An end cap of the bolt 5 abuts against the blocking edge of the sixth through-hole 331 so that the switching handle 33 is fixedly connected to the free end of the connecting rod 32. Preferably, in order to prevent the end cap of the bolt 5 from being exposed to the outside to affect the appearance, an outer end face of the switching handle 33 is provided with a snap-fit cover cover 9 flush with it. The snap-fit cover 9 is snap-fitted into the sixth through-hole 331, and an inner end of the snap-fit cover 9 is provided with an avoidance portion 91 for avoiding interference with the end cap of the bolt 5. When the water outflow device of the present disclosure switches the water channel, the switching handle 33 is driven to swing circumferentially around the central axis X of the pivoting passage 22, so that the water outlets 3131 of the water distribution valve spool 31 are selectively docked and communicated with the water inlets 21 of the water distribution disc 23, so as to realize the water channel switching of different functional water sprays of the water outflow device.

As shown in FIG. 5, an end face of the water distribution disc 23a on a side facing the water blocking sheet 23b is provided with a column 233 protruding outward at a position corresponding to the connecting rod 32, and the column 233 is provided with a pivoting passage 22; second through-holes 242 communicating with each other are formed on the water blocking sheet 23b and the water outflow surface cover 24b at positions corresponding to the column 233, and the column 233 is placed in the second through-holes 242 and partially protrudes out. The switching handle 33 is arranged outside the column 233, and an annular groove 100 is formed between the free end of the column 233 and the switching handle 33 for placing a wear gasket 7. When the switching handle 33 swing circumferentially around the central axis X of the pivoting passages 22, the wear gasket 7 can reduce abrasion between the switching handle 33 and the column 233.

The specific working principle of the present disclosure will be described as follows.

By driving the switching handle 33 to swing circumferentially around the central axis X of the pivoting passages 22, and then driving the water distribution valve spool 31 to rotate synchronously, the two water outlets 3131 of the water distribution valve spool 31 are selectively docked with the two water inlets 21 of the water distribution disc 23. Water from the external water source flows into the first water accommodating chamber 3121 through the water inflow terminal 131 and the water inflow passage 3111 in sequence, flows into the corresponding water inlets 21 of the water distribution disc 23 through the two water outlets 3131, and then flows into the corresponding second water accommodating chamber 232. Different functional water sprays, such as shower water, mist water, blade water, etc., are sprayed out through the corresponding water-passing holes 25 and water outflow terminal groups 240a, 240b, 240c and 240d in sequence; of course, if the hole diameter of each water outlet 3131 of the water distribution valve spool 31 is large enough, by rotating the water distribution valve spool 31, the water outlets 3131 are docked and communicated with two water inlets 21 with different functional water sprays but adjacent to each other. At this time, the water outflow panel assembly 24 sprays out two different functional water sprays simultaneously, that is, a water outflow form of mixed water. Alternatively, the two water outlets 3131 of the water distribution valve spool 31 are respectively docked and communicated with the water inlets 21 with two different functional waters sprays. At this time, the water outflow panel assembly 24 also sprays out two different functional water sprays simultaneously.

With the above design of the water outflow device of the present disclosure, since the water selectively flows toward the water inlets 21 of the water outflow assembly 2 through the water outlets 3131 of the water distribution valve spool 31, and is sprayed out after passing through the water accommodating chamber of the water outflow assembly 2, the water pressure in the water distribution valve spool 31 is lower than the water pressure in the water outflow assembly 2 when water is coming out of the water outflow device. Therefore, a smaller pushing force can be used to drive the water distribution valve spool 31 to rotate in the circumferential direction through the switching handle 33, so as to realize switching of the water channel. At the same time, the water outflow assembly 2 of the present disclosure is fixed on the body 1, which avoids water leakage caused by the wear of the internal fasteners or connectors due to the rotation of the water outflow assembly in the prior art, which would otherwise shorten the service life. The structural arrangement of the water outflow device of the present disclosure solves this technical problem very well.

The above description merely relates to embodiments of the present disclosure, and is not intended to limit the design of the present disclosure. Any equivalent changes made according to key points of the design of the present disclosure will fall within the scope of protection of the present disclosure.

We claim:

1. An easy-to-switch water outflow device, comprising:
a body, on which an accommodating chamber is formed, a water inflow terminal communicating with an external water source being formed in the accommodating chamber;
a water outflow assembly, which is fixedly installed on the accommodating chamber of the body, and which is at least capable of spraying out two different functional water sprays, wherein for each of the functional water sprays, the water outflow assembly is provided with at least one water inlet communicating with a water channel of the functional water spray on an end face of the water outflow assembly on a side facing the body; the water outflow assembly is provided with a through pivoting passage at a position corresponding to the water inflow terminal, and the pivoting passage is isolated from water channels in the water outflow assembly; and
a water channel switching device, which comprises a water distribution valve spool, a connecting rod and a switching handle; wherein the water distribution valve spool is located between the accommodating chamber of the body and the water outflow assembly, and the water distribution valve spool is formed with a water inflow passage that can be rotationally docked with the water inflow terminal on an end face on a side facing the accommodating chamber, and is formed with at least one water outlet on the other end face; water from the external water source flows into the water distribution valve spool through the water inflow terminal and the water inflow passage in sequence, and flows out through the water outlet; the switching handle is arranged on an outer end face of the water outflow assembly; the connecting rod is built in the pivoting passage, with one end of the connecting rod being fixedly connected to the water distribution valve spool, and the other end of the connecting rod being fixedly connected to the switching handle; by driving the switching handle to swing circumferentially around a central axis X of the pivoting passage, the water outlet of the water distribution valve spool can be selectively docked with the water inlet of the water outflow assembly so that the water channel is conducted, thereby realizing the switching of water channels of different functional water sprays of the water outflow device.

2. The water outflow device according to claim 1, wherein an inner wall of the accommodating chamber of the body forms a water collecting trough that communicates with the external water source, and an outer end of the water collecting trough is fixedly connected with a water blocking cover plate; on the water blocking cover plate, a water-passing protrusion extends outward and communicates with the water channel in the water collecting trough, and the water-passing protrusion is the water inflow terminal; the water distribution valve spool is formed with a first through-hole on an end face on a side facing the water-passing protrusion, and the first through-hole is the water inflow passage; the water-passing protrusion is inserted into the first through-hole, a sealing ring is provided between the water-passing protrusion and an inner wall of the first through-hole that abuts against the water-passing protrusion, and the water distribution valve spool can rotate in a circumferential direction relative to the water-passing protrusion.

3. The water outflow device according to claim 2, wherein the water distribution valve spool is symmetrically provided with two water outlets with the pivoting passage as a central axis X; for each of the functional water sprays, the water outflow assembly is provided with two water inlets on an end face facing inwardly, and the two water inlets can be docked and communicated with the two water outlets of the water distribution valve spool.

4. The water outflow device according to claim 3, wherein the water distribution valve spool is cylindrical, and comprises an upper cover, a valve spool body and two water-passing rubber pads; the upper cover is fixedly arranged on an upper end of the valve spool body, and the upper cover is provided with a first through-hole which is configured as the water inflow passage; an inner chamber of the valve spool body forms a first water accommodating chamber, an end face of the valve spool body on a side away from the upper cover is formed with two accommodating grooves, and each of the accommodating grooves is provided therein with at least one water-passing through-hole communicating with the first water accommodating chamber of the valve spool body; the water-passing rubber pads are placed in the accommodating grooves, a water outlet is provided on the water-passing rubber pad, and the water outlets can be selectively communicated with the water inlets of the water outflow assembly.

5. The water outflow device according to claim 4, wherein the connecting rod is fixedly provided on a bottom end face of the valve spool body through integral forming; the switching handle is fixedly connected to a free end of the connecting rod in a detachable/installable way, and the switching handle moves in association with the free end.

6. The water outflow device according to claim 4, wherein a plurality of positioning countersunk holes are circumferentially distributed on the upper cover with the first through-hole as the center, and two stoppers extend outward on diametrical ends of the upper cover; a positioning elastic post is provided between the upper cover and the water blocking cover plate, and the water blocking cover plate is provided with a limiting block on an outer side relative to the diametrical ends of the upper cover; when the switching handle drives the water distribution valve spool to rotate, the positioning elastic post can switch between the positioning countersunk holes to generate a positioning sound, and the limiting block can abut against the two stoppers of the upper cover respectively for limiting, so that a rotational angle of the water distribution valve spool is limited.

7. The water outflow device according to claim 4, wherein the end face of the water outflow assembly that faces inwardly is formed with a concave abutting plane in the area of the water inlets, the abutting plane is adapted to an outer diameter of the valve spool body, and the valve spool body rotates circumferentially relative to the abutting plane.

8. The water outflow device according to claim 1, wherein the water outflow assembly comprises a water distribution assembly and a water outflow panel assembly that are fixedly connected to each other, and at least two second water accommodating chambers whose water channels are isolated from each other are formed in an inner chamber of the water distribution assembly; a side of the water distribution assembly that faces the accommodating chamber is a water inflow end face, and the other side is a water outflow end face; each of the second water accommodating chambers is provided with at least one water inlet communicating therewith on the water inflow end face at the corresponding position, and at the same time, each of the second water accommodating chambers is provided with at least one water-passing hole communicating therewith on the water outflow end face at the corresponding position; the water outflow panel assembly is provided with water outflow terminal groups having the same number as the second water accommodating chambers; each of the water outflow terminal groups can only communicate with the water-passing hole of the second water accommodating chamber at the corresponding position, so as to generate a specific functional water spray; at the same time, the water distribution assembly and the water outflow panel assembly are formed with pivoting passages that communicates with each other, the pivoting passages are respectively isolated from the water channels of the water distribution assembly and the water outflow panel assembly, and the pivoting passages are opposite to the position of the water inflow terminal.

9. The water outflow device according to claim 8, wherein the water distribution assembly comprises a water distribution disc and a water blocking sheet in sequence from the inside to the outside in an axial direction; the water outflow panel assembly comprises a water outflow rubber pad and a water outflow surface cover in sequence from the inside to the outside in the axial direction; the water distribution disc and the water blocking sheet are snap-fitted and fixed to each other, so that an interior thereof forms at least two second water accommodating chambers whose water channels are isolated from each other; an end face of the water distribution disc on a side facing the water blocking sheet is provided with a column protruding outward at a position corresponding to the connecting rod, and the column is provided with a pivoting passage; second through-holes communicating with each other are formed on the water blocking sheet and the water outflow surface cover at positions corresponding to the column, and the column is placed in the second through-holes and partially protrudes out; the switching handle is arranged outside the column, and an annular groove is formed between a free end of the column and the switching handle for placing a wear gasket, the wear gasket can reduce abrasion between the switching handle and the column.

10. The water outflow device according to claim 9, further comprising a decorative surface cover, which is fixedly arranged at an outer end of the water outflow surface cover; wherein the decorative surface cover is provided with a third through-hole at a position corresponding to the second through-hole, and is correspondingly provided with a plurality of fourth through-holes at positions corresponding to the water outflow terminal groups; at the same time, the switching handle is arranged at the outer end of the decorative surface cover instead of being arranged at the outer end of the water outflow surface cover.
